(19) United States
(12) Patent Application Publication
(10) Pub. No.: US 2005/0228074 A1
(43) Pub. Date: Oct. 13, 2005

(54) Amphiphilic polymer micelles and use thereof

(75) Inventors: Sandra M. Warren, Massillon, OH (US); Xiaorong Wang, Hudson, OH (US)

Correspondence Address: Bridgestone Americas Holding, Inc., 1200 Firestone Parkway, Akron, OH, 44317-0001, US

(73) Assignee: Bridgestone Corporation, Tokyo (JP)

(21) Appl. No.: 10/817,995

(22) Filed: Apr. 5, 2004

(51) Int. Cl. B32B 1/00; B32B 27/00

(52) U.S. Cl. 523/201; 428/403; 428/407

(57) ABSTRACT

A nano-particle composition including a polar core and a hydrophobic surface layer is provided. The nano-particles have a mean average diameter less than about 100 nm. Methods are disclosed for making and using the nano-particles. The nano-particles can be modified via, for example, hydrogenation or functionalization. The nano-particles can advantageously be incorporated into rubbers, elastomers, and thermoplastics.

### FIELD OF THE INVENTION

The present invention relates to polymer nano-particles, methods for their preparation, and their use as, for example, additives for rubber, including natural and synthetic elastomers. The invention advantageously provides several mechanisms for surface modifications, functionalization, and general characteristic tailoring to improve performance in rubbers, elastomers, and thermoplastics.

Polymer nano-particles have attracted increased attention over the past several years in a variety of fields including catalysis, combinatorial chemistry, protein supports, magnets, and photonic crystals. Similarly, vinyl aromatic (e.g. polystyrene) microparticles have been prepared for uses as a reference standard in the calibration of various instruments, in medical research and in medical diagnostic tests. Such polystyrene microparticles have been prepared by anionic dispersion polymerization and emulsion polymerization.

### TECHNICAL BACKGROUND

Nano-particles can be discrete particles uniformly dispersed throughout a host composition. Nano-particles preferably are monodisperse in size and uniform in shape. However, controlling the size of nano-particles during polymerization and/or the surface characteristics and high temperature properties of such nano-particles can be difficult. Accordingly, achieving better control over the surface composition of such polymer nano-particles or the high temperature characteristics is desirable.

Rubbers may be advantageously modified by the addition of various polymer compositions. The physical properties of rubber moldability and tenacity are often improved through such modifications. Moreover, it is expected that primarily the selection of nano-particles having suitable size, physical properties, material composition, and surface chemistry, etc., will improve the matrix characteristics.

In this regard, development of nano-particles having improved properties within certain temperature ranges would be compatible with a wide variety of matrix materials and is desirable because discrete particles could likely disperse evenly throughout the host to provide a uniform matrix composition. However, the development of a process capable of reliably producing acceptable nano-particles has been a challenging endeavor. Moreover, the development of a solution polymerization process producing reliable nano-particles, particularly nano-particles advantageously employed in rubber compositions, has been elusive.

### SUMMARY OF THE INVENTION

The present invention provides nano-particles, methods of preparing the nano-sized polymer particles, and compositions containing the nano-particles, such as rubber compositions, thermoplastic elastomer compositions, tires, hard disk drive gasket compositions, engine mounts and vulcanizable elastomeric compositions.

Each inventive nano-particle includes a micelle having a polar core and a hydrophobic shell wherein the polar core has at least one oxygen, nitrogen, or sulfur atom and the nano-particle has a mean average diameter less than about 100 nanometers.

The present invention includes a method of preparing nano-size polymer particles, including polymerizing a plurality of monomers in a hydrocarbon solvent to form a polymer, and combining a polar cross-linking agent with the polymer to produce nano-size polymer particles having a polar core and a hydrophobic shell. The nano-size polymer particles have a mean average diameter of less than about 100 nanometers.

Accordingly, one advantage of the present invention is to synthesize new polymers having improved high temperature properties.

Another advantage of the present invention is to provide micelles having a polar core and a hydrophobic shell.

Still another advantage of the present invention is to provide a micelle having a polar core with the size of about 100 nanometers or less.

Another advantage of the present invention is to provide a nano-particle having improved properties at temperatures of 100° C. or higher.

Still another advantage of the present invention is to provide a new method of preparing nano-sized particles.

Yet another advantage of the present invention is to synthesize a polymer having improved high temperature characteristics so that such polymer may be used in rubber, engine mounts, tires, and hard disk drive gaskets.

### BRIEF DESCRIPTION OF THE DRAWINGS

FIGS. 1(A)-(E) shows the chemical structure of certain acrylate containing cross-linking agents, including, bisphenol A ethoxylate diacrylate (FIG. 1A), (diethylene glycol) diacrylate (FIG. 1B), glycerol propoxylate triacrylate (FIG. 1C), poly(ethylene glycol) diacrylate (FIG. 1D), and trimethylol propane ethoxylate triacrylate (FIG. 1E).

FIG. 2 shows the general chemical formula of an acrylate containing cross-linking agent. The large circle represents the remainder of the chemical structure.

### DETAILED DESCRIPTION OF THE INVENTION

The present invention provides nano-particles, and methods of synthesis thereof, displaying superior properties at elevated temperatures. The nano-particles disclosed herein have improved physical properties at temperature above 100° C. Such nano-particles are highly desirable for use in devices requiring performance and durability at such elevated temperatures. Such devices include, but are not limited to, rubbers, tires, engine mounts, and hard disk drive gaskets.

General Nano-Particle Process of Formation

This application incorporates by reference U.S. Pat. No. 6,437,050 issued Aug. 20, 2002; U.S. Pat. No. 6,689,469 issued Feb. 10, 2004; and U.S. Patent Publication No. 20030198810 A1 published Oct. 23, 2003.

One exemplary polymer nano-particle of the present invention is formed from diblock polymer chains having at least a poly(conjugated diene) block and a poly(alkenylbenzene) block. The poly(alkenylbenzene) blocks may be cross-linked to form the desired nanoparticles. The nano-particles have diameters—expressed as a mean average diameter—that are preferably less than about 100 nm, more preferably less than about 75 nm, and most preferably less than about 50 nm. The nano-particles preferably are substantially monodisperse and uniform in shape. The polydispersity of the nano-particle is represented by the ratio of M_{w} (weight average molecular weight) to Mₙ (number average molecular weight), with a ratio of 1.3 or less being substantially monodisperse. The polymer nano-particles of the present invention preferably have a dispersity of less than about 1.3, more preferably less than about 1.2, and most preferably less than about 1.1. Moreover, the nano-particles are preferably spherical, though shape defects are acceptable, provided the nano-particles generally retain their discrete nature with little or no polymerization between particles.

Herein throughout, unless specifically stated otherwise: “vinyl-substituted aromatic hydrocarbon” and “alkenylbenzene” are used interchangeably; and “rubber” refers to rubber compounds, including natural rubber, and synthetic elastomers including styrene-butadiene rubber, ethylene propylene rubber, etc., which are known in the art.

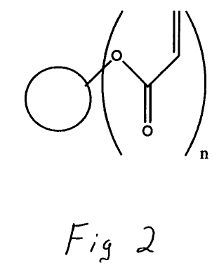

As used herein, “acrylate containing cross-linking agent” means a compound containing an acrylate, diacrylate, triacrylate, etc. As that term is used herein, it means molecules having the general chemical structure for acrylate containing cross-linking agents, as provided in FIG. 2. In a preferred embodiment of FIG. 2, “n” comprises an integer, more preferably the integer 2 or higher. Such cross-linking agents cross-link the center core of the micelle (i.e. alkenylbenzene) to form the desired nano-particle. Accordingly, the cross-linking agent is ultimately located in the center core of the micelle. Consequently, nano-particles are formed from the micelles with a core including, for example, styrene monomer units and a surface layer including, for example, butadiene monomer units. In certain embodiments, an acrylate containing cross-linking agent may not have functional groups, such as alcohol or carboxylic acids, which interfere with anionic polymerization. With regard to the micelles described herein, the cores of the micelles may include an acrylate containing cross-linking agent. Examples of acrylate containing cross-linking agents include, but are not limited to, bisphenol A ethoxylate diacrylate, (diethylene glycol) diacrylate, glycerol propoxylate triacrylate, poly(ethylene glycol) diacrylate, and trimethylol propane ethoxylate triacrylate and mixtures thereof.

The nano-particles are preferably formed via dispersion polymerization, although emulsion polymerization is also contemplated. Hydrocarbons are preferably used as the dispersion solvent. Suitable solvents include aliphatic hydrocarbons, such as pentane, hexane, heptane, octane, nonane, decane, and the like, as well as alicyclic hydrocarbons, such as cyclohexane, methyl cyclopentane, cyclooctane, cyclopentane, cycloheptane, cyclononane, cyclodecane and the like. Such solvents are well known in the art and are widely commercially available. These hydrocarbons may be used individually or in combination. In a particular embodiment, as more fully described herein below, selection of a solvent in which one polymer forming the nano-particles is more soluble than another polymer forming the nano-particles may be beneficial in micelle formation.

With respect to the monomers and solvents identified herein, nano-particles are formed by maintaining a temperature that is favorable to polymerization of the selected monomers in the selected solvent(s). Preferred temperatures are in the range of about −78 to 250° C., more preferably −40 to 250° C., and even more preferably 0 to 250° C., and with a temperature in the range of about 0 to 150° C. being most particularly preferred. As described in more detail below, the interaction of monomer selection, temperature, and solvent facilitates the formation of block polymers which form micelles and ultimately the desired nano-particles.

According to one embodiment of the invention, a diblock polymer is formed of vinyl aromatic hydrocarbon monomers and conjugated diene monomers in the hydrocarbon solvent. The diblock polymer contains at least a first end block that is soluble in the dispersion solvent, preferably a conjugated diene monomer, and at least a second end block which is less soluble in the dispersion solvent, preferably a vinyl-substituted aromatic hydrocarbon monomer. Moreover, in one preferred embodiment, a vinyl-substituted aromatic hydrocarbon monomer is chosen, the polymer of which is generally insoluble in the dispersion solvent.

Such a diblock copolymer may be formed by live anionic polymerization, in which a vinyl-substituted aromatic hydrocarbon monomer is added to a completely polymerized conjugated diene monomer. Another method of forming substantially diblock polymers is the living anionic copolymerization of a mixture of monomers, such as a conjugated diene monomer and a vinyl-substituted aromatic hydrocarbon monomer in a hydrocarbon solvent, particularly, in the absence of certain polar additives, such as ethers, tertiary amines, or metal alkoxides which could otherwise affect the polymerization of the separately constituted polymer blocks. Under these conditions, the conjugated diene generally polymerizes first, followed by the polymerization of the vinyl-substituted aromatic hydrocarbon. Alternatively, the polymer may be formed by random polymerization.

Nonetheless, it is generally preferred that a vinyl substituted aromatic hydrocarbon polymerize last, positioning the live end of the polymerizing polymer on a vinyl aromatic block to facilitate later cross-linking.

Such copolymers, formed by either method, to aggregate to form micelle-like structures, with for example, vinyl-substituted aromatic blocks directed toward the centers of the micelles and conjugated diene blocks as tails extending therefrom. It is noted that a further hydrocarbon solvent charge or a decrease in polymerization mixture temperature may also be used, to obtain formation of the micelles. Moreover, these steps may be used to take advantage of the general insolubility of the vinyl-aromatic blocks. An exemplary temperature range for micelle formation is between about 40° C. and 100° C., more preferably between about 50° C. and 80° C.

After the micelles have formed, additional conjugated diene monomer and/or vinyl-substituted aromatic hydrocarbon monomer can be added to the polymerization mixture as desired.

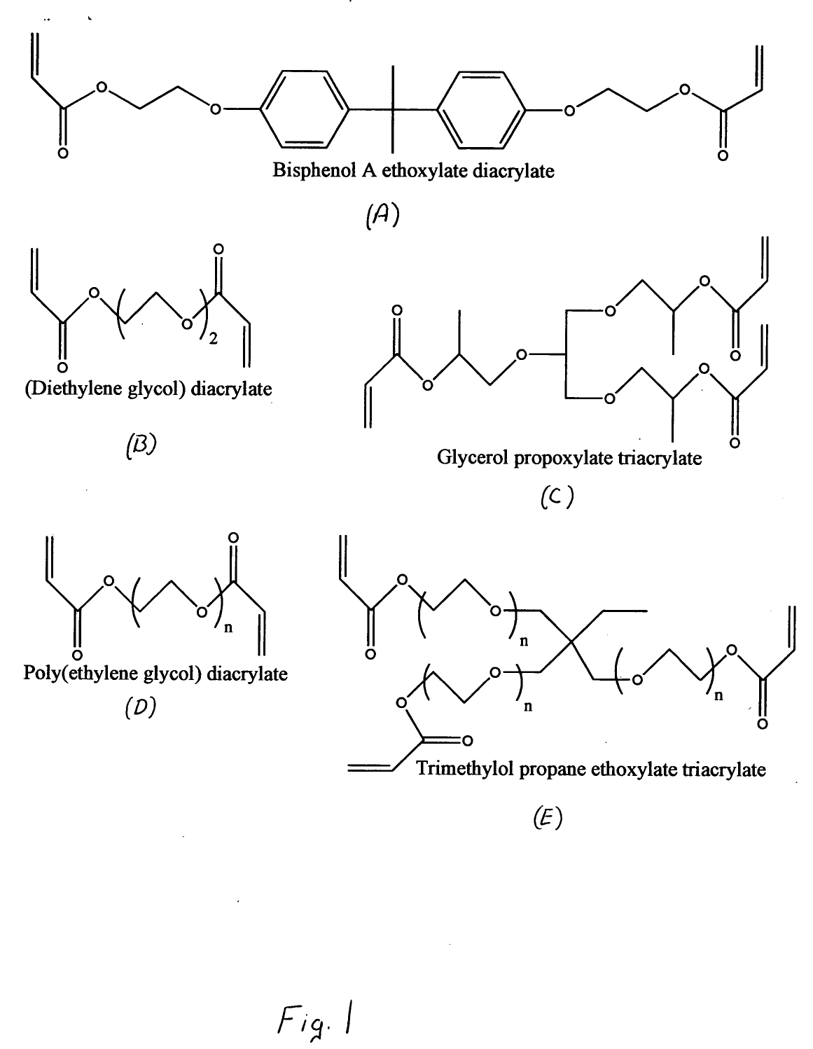

After formation of the micelles, a cross-linking agent is added to the polymerization mixture. Preferably, a cross-linking agent is selected which has an affinity to the vinyl-substituted aromatic hydrocarbon monomer blocks and migrates to the center of the micelles due to its compatibility with the monomer units and initiator residues present in the center of the micelle and its relative incompatibility with the dispersion solvent and monomer units present in the outer layer of the micelle. Furthermore, the cross-linking agent may be a polar molecule. Preferably, the cross-linking agent is an acrylate containing cross-linking agent. In certain embodiments, the cross-linking agent has a solubility parameter of 8.5 or greater. One of ordinary skill in the art understands and is able to calculate the solubility parameter as needed. By way of example, the solubility parameter is [Cal cm⁻³]^{1/2}. By way of illustration, but not limitation, the following cross-linking agents are desirable: bisphenol A ethoxylate diacrylate, (diethylene glycol) diacrylate, glycerol propoxylate triacrylate, poly(ethylene glycol) diacrylate, and trimethylol propane ethoxylate triacrylate. As a further example of the solubility characteristics of acrylate containing cross-linking agents which are suitable, tetrahydrofuran (THF) was added, as indicated below, so that each of the following compounds becomes soluble in hexane. When 1 gram of the cross-linking agent is mixed with 15 grams of hexane, the following volumes of THF are needed for the compound to be soluble in the hexane: bisphenol A ethoxylate diacrylate, 7.5 ml; (diethylene glycol) diacrylate, 5.0 ml; glycerol propoxylate triacrylate, 0 ml; poly(ethylene glycol) diacrylate, 15 ml; and trimethylol propane ethoxylate triacrylate, 10 ml. The chemical structure of the listed cross-linking agents is provided in FIG. 1. The above listed desirable cross-linking agents are commercially available from several sources, such as Aldrich of Milwaukee, Wis. Examples of such polar molecules may include molecules having oxygen, nitrogen, and/or sulfur.

The above listed examples of cross-linking agents are several members of a category of molecules called “acrylate containing cross-linking agents.” As that term is used herein, it means molecules having the general chemical structure for acrylate containing cross-linking agents, as provided in FIG. 2. Such cross-linking agents cross-link the center core of the micelle (i.e. alkenylbenzene) to form the desired nano-particle. Accordingly, the cross-linking agent is ultimately located in the center core of the micelle. Consequently, nano-particles are formed from the micelles with a core including, for example, styrene monomer units and a surface layer including, for example, butadiene monomer units.

In certain embodiments, the micelles formed by the polymerization of vinyl-substituted aromatic hydrocarbons and conjugated diene monomers are cross-linked to enhance the uniformity and permanence of shape and size of the resultant nano-particle. In such embodiments, cross-linking agents are di- or tri-vinyl-substituted aromatic hydrocarbons. However, cross-linking agents which are at least bifunctional, wherein the two functional groups are capable of reacting with vinyl-substituted aromatic hydrocarbon monomers are acceptable. For example, in certain embodiments, divinylbenzene may be used to aid in the synthesis of micelles. However, those micelles are subsequently modified when the acrylate containing cross-linking agent is added. The micelles to which the acrylate containing cross-linking agent is added have different characteristics as further described herein.

One example of preferred conjugated diene monomers for the block polymer are those soluble in non-aromatic hydrocarbon solvents. C₄-C₈ conjugated diene monomers are the most preferred. Such monomers are widely commercially available from sources such as Aldrich of Milwaukee, Wis., or other commercial suppliers. Exemplary conjugated diene monomers include 1,3-butadiene, isoprene, and 1,3-pentadiene, which are also commercially available from Exxon Mobil Chemical Company or Shell Chemical Company.

Vinyl-substituted aromatic hydrocarbon monomers include styrene, α-methylstyrene, 1-vinyl naphthalene, 2-vinyl naphthalene, 1-α-methyl vinyl naphthalene, 2-α-methyl vinyl naphthalene, vinyl toluene, methoxystyrene, t-butoxystyrene, and the like, as well as alkyl, cycloalkyl, aryl, alkaryl, and aralkyl derivatives thereof, in which the total number of carbon atoms in the combined hydrocarbon is generally not greater than 18, as well as any di- or tri-vinyl substituted aromatic hydrocarbons, and mixtures thereof. Again, such monomers are well known in the art and widely commercially available from sources such as Aldrich of Milwaukee, Wis. An example of a commercial supplier for styrene is Lyondell of Houston, Tex.

The diblock polymer, preferably has M_{w} of about 5,000 to 200,000, more preferably between about 10,000 and 100,000. A typical diblock polymer will be comprised of 5% to 95% by weight conjugated diene and 5% to 95% by weight vinyl-substituted aromatic hydrocarbon, more preferably 20% to 80% by weight, and most preferably 40% to 60% by weight of each contributed monomer type.

In certain embodiments, a 1,2-microstructure controlling agent or randomizing modifier is optionally used to control the 1,2-microstructure in the conjugated diene contributed monomer units, such as 1,3-butadiene, of the nano-particle. Such modifiers are well known in the art and are commercially available from Exxon Mobil Chemical Company or Shell Chemical Company. Suitable modifiers include, but are not limited to, hexamethylphosphoric acid triamide, N,N,N′,N′-tetramethylethylene diamine, ethylene glycol dimethyl ether, diethylene glycol dimethyl ether, triethylene glycol dimethyl ether, tetraethylene glycol dimethyl ether, tetrahydrofuran, 1,4-diazabicyclo[2.2.2]octane, diethyl ether, triethylamine, tri-n-butylamine, tri-n-butylphosphine, p-dioxane, 1,2-dimethoxy ethane, dimethyl ether, methyl ethyl ether, ethyl propyl ether, di-n-propyl ether, di-n-octyl ether, anisole, dibenzyl ether, diphenyl ether, dimethylethylamine, bis-oxalanyl propane, tri-n-propyl amine, trimethyl amine, triethyl amine, N,N-dimethyl aniline, N-ethylpiperidine, N-methyl-N-ethyl aniline, N-methylmorpholine, tetramethylenediamine, oligomeric oxolanyl propanes (OOPs), 2,2-bis-(4-methyl dioxane), and bistetrahydrofuryl propane. A mixture of one or more randomizing modifiers also can be used. The ratio of the modifier to the monomers can vary from a minimum as low as 0 to a maximum as great as about 4000 millimoles, preferably about 0.01 to 3000 millimoles, of modifier per hundred grams of monomer currently being charged into the reactor. As the modifier charge increases, the percentage of 1,2-microstructure (vinyl content) increases in the conjugated diene contributed monomer units in the surface layer of the polymer nano-particle. The 1,2-microstructure content of the conjugated diene units is preferably between about 1% and 99%, more preferably between about 5% and 95%.

Without being bound by theory, it is believed that an exemplary micelle will be comprised of ten to five hundred diblock polymers yielding, after cross-linking, a nano-particle having a M_{w} of between about 5,000 and 100,000,000, preferably between about 5,000 and 10,500,000.

In certain embodiments, the polar core may have at least one oxygen atom. In certain embodiments, the micelle includes an acrylate containing cross-linking agent or both an acrylate containing cross-linking agent and divinylbenzene. It also includes a monomer. In certain embodiments, the cross-linking agent includes an acrylate containing cross-linking agent. In other embodiments, the monomer is a vinyl-substituted aromatic hydrocarbon. In still other embodiments, the micelle includes a polymerization reaction product. In certain embodiments, the polymerization reaction product is the result of a multi-stage polymerization.

The present invention also includes a rubber composition including a rubber, and a plurality of nano-particles, at least a majority of the nano-particles monodispersed in the rubber, with the nano-particles including a polymerization reaction product including a micelle, the micelle comprising a polar core and the hydrophobic shell, wherein the polar core comprises at least one oxygen, nitrogen, or sulfur atom, and at least one of the nano-particles has a mean average diameter less than about 100 nanometers. In an additional embodiment, the polar core comprises at least one oxygen atom.

In certain embodiments of the method, the ratio by weight of the plurality of monomers to the polar cross-linking agent is from about 0.1:1 to about 5:1. In alternate embodiments, the ratio by weight of the plurality of monomers to the polar cross-linking agent is from about 0.5:1 to about 5:1. In other alternate embodiments, the ratio by weight of the plurality of monomers to the polar cross-linking agent is from about 0.5:1 to about 2:1. In still other embodiments of the method of preparing nano-size polymer particles, the polymerizing step is performed in a temperature range from about 0° C. to about 250° C. In still other embodiments of the method, the plurality of monomers includes alkenylbenzene and conjugated diene monomers. Other embodiments of the method include a plurality of monomers such as a vinyl aromatic hydrocarbon monomer, a vinyl-substituted aromatic hydrocarbon monomer, or a conjugated diene monomer. In still other embodiments of the method, the polar cross-linking agent has at least one oxygen, sulfur, or nitrogen atom.

The present invention also includes a nano-particle composition including a polar core and a surface layer including poly(conjugated diene), poly(alkylene), or mixtures thereof wherein the nano-particles have a mean average diameter of less than about 100 nanometers. Other embodiments of the nano-particle composition include at least one functional group. Still other embodiments of the composition have a functional group associated with the surface layer. In still other embodiments of the nano-particle composition, the surface layer includes vinyl-substituted aromatic hydrocarbon monomer units. In other embodiments of the nano-particle composition, the surface layer includes at least one diblock polymer chain. In still other embodiments of the present invention, the core includes substantially at least one mono-block polymer chain. In still other embodiments, the mono-block polymer chain and the diblock polymer chains are cross-linked. In still other embodiments, the acrylate containing cross-linking agent is selected from the group of bisphenol A ethoxylate diacrylate, (diethylene glycol) diacrylate, glycerol propoxylate triacrylate, poly(ethylene glycol) diacrylate, and trimethylol propane ethoxylate triacrylate. However, in addition to the crossing-linking agents listed above, other equivalent acrylate containing compounds may be used.

The present invention also includes a rubber composition having a rubber, and a polymer nano-particle having a core and a surface layer including monomer units such as conjugated dienes, alkylenes, and mixtures thereof, the core comprising poly(alkenylbenzene) and an acrylate containing cross-linking agent. Other embodiments of the rubber composition also include an inorganic filler. Still other embodiments of the rubber composition include a rubber selected from the group consisting of random styrene/butadiene copolymers, butadiene rubber, polyisoprene, nitrile rubber, polyurethane, butyl rubber, EPDM, and mixtures thereof. In still other embodiments of the rubber composition, the polymer nano-particle includes a functional group selected from the group consisting of amines, tin, silyl ethers, silicon, and mixtures thereof. In other embodiments, of the rubber composition, the polymer nano-particle includes a function group selected from the group consisting of carboxylic acid, alcohol, amine, formyl, tin, silicon, silyl ether, and mixtures thereof. In certain embodiments, the functional group may be protected. When a compound having a protected functional group is desired, such compounds are commercially available. In other embodiments, the temperature range in which the functional groups are used is reduced to −78° C. In still other embodiments of the rubber composition, the surface layer includes alkenylbenzene monomer units. In yet other embodiments, the acrylate containing cross-linking agent is selected from the group of bisphenol A ethoxylate diacrylate, (diethylene glycol) diacrylate, glycerol propoxylate triacrylate, poly(ethylene glycol) diacrylate, and trimethylol propane ethoxylate triacrylate and mixtures thereof.

The present invention additionally includes a thermal plastic elastomer composition including a thermal plastic elastomer, and a polymer nano-particle including a core and a surface layer having monomer units including conjugated dienes, alkylenes, and mixtures thereof. The core including poly(alkenylbenzene) and an acrylate containing cross-linking agent. In alternate embodiments, the acrylate containing cross-linking agent is selected from the group consisting of bisphenol A ethoxylate diacrylate, (diethylene glycol) diacrylate, glycerol propoxylate triacrylate, poly(ethylene glycol) diacrylate, and trimethylol propane ethoxylate triacrylate and mixtures thereof.

Other embodiments of the thermal plastic elastomer composition include a sufficient amount of an extender to form a gel. Still other embodiments of the invention include a thermal plastic elastomer selected from the group consisting of polystyrene-poly(ethylenepropylene)-polystyrene triblock copolymer (SEPS), polystyrene-poly(ethylene-butene)-polystyrene triblock copolymer (SEBS), polystyrene-poly(ethylenepropylene)-polyethylene triblock copolymer (SEPE), polystyrene-poly(ethylene-butene)-polyethylene triblock copolymer (SEBE), polyethylene-poly(ethylene-butene)-polyethylene triblock copolymer (EEBE), polyethylene-poly(ethylene-propylene)-polyethylene triblock copolymer (EEPE), polypropylene, polyethylene, polystyrene, and mixtures thereof.

The present invention also includes rubber composition including a rubber, a silica, and a polymer nano-particle having a core and a surface layering including monomer units having conjugated dienes, alkylenes, alkenylbenzene, and mixtures thereof, the core including poly(alkylbenzene) and an acrylate containing cross-linking agent. In alternate embodiments, the rubber composition as a polymer nano-particle including a functional group selected from the group consisting of carboxylic acid, alcohol, amine, formyl, tin, silicon, silyl ether, and mixtures thereof. In still other embodiments, the acrylate containing cross-linking agent is selected from the group consisting of bisphenol A ethoxylate diacrylate, (diethylene glycol) diacrylate, glycerol propoxylate triacrylate, poly(ethylene glycol) diacrylate, and trimethylol propane ethoxylate triacrylate and mixtures thereof. The present invention also includes a tire made of the composition described within this paragraph.

The present invention also includes a hard disk drive gasket composition including a rubber, a polyalkylene, and a polymer nano-particle including a core and a surface layer including monomer units selected from the group consisting of conjugated dienes, alkylenes, alkenylbenzenes, and mixtures thereof, the core including poly(alkenylbenzene) and an acrylate containing cross-linking agent. In certain embodiments, the hard disk drive gasket composition also includes a rubber selected from the group consisting of random styrene/butadiene copolymers, butadiene rubber, polyisoprene, nitrile rubber, polyurethane, butyl rubber, ethylene-propylene terpolymer (EPDM), and mixtures thereof. In still other embodiments, the invention includes a polymer nano-particle further comprising a functional group selected from the group consisting of carboxylic acids, alcohols, amines, formyl, tin, silica, and mixtures thereof. In still other embodiments, the acrylate containing cross-linking agent is selected from the group consisting of bisphenol A ethoxylate diacrylate, (diethylene glycol) diacrylate, glycerol propoxylate triacrylate, poly(ethylene glycol) diacrylate, and trimethylol propane ethoxylate triacrylate and mixtures thereof.

The present invention also includes a matrix composition including a host, and a polymer nano-particle having a core and a surface layer including monomer units including conjugated dienes, alkylenes, and mixtures thereof, the core including poly(alkenylbenzene) and an acrylate containing cross-linking agent. The present invention also includes a vulcanizable elastomer composition including a rubber, a nano-particle including a diacrylate, a reinforcing filler, and a curing agent including an effective amount of sulfur to achieve sufficient cure. The invention also includes an engine mount including the composition also described in this paragraph. In still other embodiments, the acrylate containing cross-linking agent is selected from the group consisting of bisphenol A ethoxylate diacrylate, (diethylene glycol) diacrylate, glycerol propoxylate triacrylate, poly(ethylene glycol) diacrylate, and trimethylol propane ethoxylate triacrylate and mixtures thereof. The invention also includes a tire made of the composition disclosed in this paragraph.

Finally, the invention also includes a method of preparing a functionalized polymer nano-particle including polymerizing an alkenylbenzene monomer and a conjugated diene monomer in a hydrocarbon solvent, in the presence of a functionalized initiator, to form a diblock polymer, forming a polymerization mixture including micelles of the diblock polymer, and adding an acrylate containing cross-linking agent to the polymerization mixture to form cross-linked nano-particles from the micelles, the nano-particles having a mean average less than about 100 nanometers. In certain embodiments of the method, the functionalized initiator is a functionalized lithium initiator. In still other embodiments of the method, the functionalized lithium initiator includes a functional group consisting of carboxylic acids, alcohols, amines, formyl, tin, silicon, silyl ether, and mixtures thereof. In certain embodiments, the functional group may be protected. Such compounds having protected functional groups are commercially available. Other embodiments of the method have a functionalized lithium initiator of hexamethylene imine propyllithium. In still other embodiments, the method may further include a hydrogenation step. In still another embodiment, the acrylate containing cross-linking agent is selected from the group consisting of bisphenol A ethoxylate diacrylate, (diethylene glycol) diacrylate, glycerol propoxylate triacrylate, poly(ethylene glycol) diacrylate, and trimethylol propane ethoxylate triacrylate and mixtures thereof.

Structural Modifications

In an alternative embodiment, the surface layer of the polymer nano-particle includes a copolymer including at least one alkenylbenzene monomer unit and at least one conjugated diene monomer unit. The copolymer may be random or ordered. Accordingly, the surface layer may include an SBR rubber. Herein throughout, references to a poly(conjugated diene) surface layer are understood to include copolymers of the type described here.

Similarly, the density of the nanoparticle may be controlled by including diblock and monoblock polymer chains in the micelles. One method for forming such polymer chains includes forming a first polymer of conjugated diene monomers in the hydrocarbon solvent. After formation of the first polymer, a second monomer is added to the polymerization, along with additional initiator. The second monomer polymerizes onto the first polymer to form a diblock polymer as well as forming a separate second polymer which is a mono-block polymer. The diblock polymer contains at least a first end block that is soluble in the dispersion solvent, preferably a conjugated diene monomer, and a second end block which is less soluble in the dispersion solvent, preferably a vinyl-substituted aromatic hydrocarbon monomer. In a preferred embodiment, a vinyl-substituted aromatic hydrocarbon is chosen which as a polymer is generally insoluble in the dispersion solvent.

Without being bound by theory, it is believed that a large number of mono-block polymer chains in the core of the nano-particle results in separation and less entangling of the conjugated diene tails of the diblock chains. The resultant surface layer thus may have a brush-like structure and resemble a circular type nano-micelle particle.

The multi-block polymer preferably has M_{w} of about 5,000 to 10,000,000 more preferably between about 10,000 and 200,000. In alternate embodiments, the multi-block polymer has M_{w} of about 5,000 to 200,000. A typical diblock polymer will be comprised of 5% to 95% by weight conjugated diene and 5% to 95% by weight vinyl-substituted aromatic hydrocarbon, more preferably 20% to 80% by weight of each contributed monomer, and most preferably 30% to 70% by weight of each contributed monomer type. Each block preferably has M_{w} between about 1,000 and 10,000,000, more preferably between about 2,000 and 5,000,000.

One technique, but not the only technique, that may be used to control the density of the poly(conjugated diene) surface layer of the nano-particles is disclosed below. The density may be controlled by manipulating the ratio of diblock to mono-block polymer chains. This ratio may be manipulated by altering the amount of initiator added during each step of the polymerization process. For example, a greater amount of initiator added during the polymerization of the conjugated diene monomer than added during the polymerization of the alkenylbenzene monomer would favor diblock formation over mono-block formation, resulting in a high density surface layer. Conversely, a greater amount of initiator added during the polymerization of the alkenylbenzene monomer than added during the polymerization of the conjugated diene monomer would favor mono-block formation over diblock formation, resulting in a low-density surface layer. The ratio of mono-blocks to diblocks can be from 1 to 99, preferably 10 to 90, more preferably 20 to 80.

Hydrogenation of a Nano-Particle Surface Layer

After cross-linking, the polydiene blocks may be hydrogenated to form a modified surface layer. A hydrogenation step may be carried out by methods known in the art for hydrogenating polymers, particularly polydienes. In certain embodiments, the hydrogenation method includes placing the cross-linked nano-particles in a hydrogenation reactor in the presence of a catalyst. After the catalyst has been added to the reactor, hydrogen gas (H₂) is charged to the reactor to begin the hydrogenation reaction. The pressure is adjusted to a desired range via addition of H₂, preferably between about 10 and 3000 kPa, more preferably between about 50 and 2600 kPa. H₂ may be charged continuously or in individual charges until the desired conversion is achieved. Preferably, the hydrogenation reaction will reach at least about 20% conversion, more preferably greater than about 85% conversion. The conversion reaction may be monitored by H¹ NMR.

Preferred catalysts include hydrogenation catalysts such as Pt, Pd, Rh, Ru, Ni, and mixtures thereof. The catalysts may be finely dispersed solids or absorbed on inert supports such as carbon, silica, or alumina. Especially preferred catalysts are prepared from nickel octoate, nickel ethylhexanoate, and mixtures thereof. Such catalysts are commercially available.

The surface layer formed by an optional hydrogenation step will vary depending on the identity of the monomer units utilized in the formation of the nano-particle surface layer, particularly the poly(conjugated diene) blocks. For example, if the poly(conjugated diene) block contains 1,3-butadiene monomer units, the resultant nano-particle layer after hydrogenation will be a crystalline poly(ethylene) layer. In another embodiment, a layer may include both ethylene and propylene units after hydrogenation if the non-hydrogenated poly(conjugated diene) block contains isoprene monomer units. It should be noted that the non-hydrogenated poly(conjugated diene) block may contain a mixture of conjugated diene monomer units, or even alkenylbenzene units, resulting in a mixture of monomer units after hydrogenation.

Initiators and Functionalized Nano-Particles

The present inventive process is preferably initiated via addition of anionic initiators that are useful in the copolymerization of diene monomers and vinyl aromatic hydrocarbons. Exemplary organo-lithium catalysts include lithium compounds having the formula R(Li)ₓ, wherein R represents a C₁-C₂₀ hydrocarbyl radical, preferably a C₂-C₈ hydrocarbyl radical, and x is an integer from 1 to 4. Typical R groups include aliphatic radicals and cycloaliphatic radicals. Specific examples of R groups include primary, secondary, and tertiary groups, such as n-propyl, isopropyl, n-butyl, isobutyl, t-butyl, etc.

Specific examples of exemplary initiators include ethyllithium, propyllithium, n-butyllithium, sec-butyllithium, tert-butyllithium, and the like; aryllithiums, such as phenyllithium, tolyllithium, and the like; alkenyllithiums such as vinyllithium, propenyllithium, and the like; alkylene lithium such as tetramethylene lithium, pentamethylene lithium, and the like. Among these, n-butyllithium, sec-butyllithium, tert-butyllithium, tetramethylene lithium, and mixtures thereof are preferred. Other suitable lithium inititators include one or more of p-tolyllithium, 4-phenylbutyl lithium, 4-butylcyclohexyl lithium, 4-cyclohexylbutyl lithium, lithium dialkyl amines, lithium dialkyl phosphines, lithium alkyl aryl phosphine, and lithium diaryl phosphines.

Functionalized lithium initiators are also contemplated as useful in the present copolymerization. Preferred functional groups include amines, formyl, carboxylic acids, alcohol, tin, silicon, silyl ether and mixtures thereof. In certain embodiments, compounds having functional groups which are protected may be used. Such compounds are commercially available.

In certain embodiments, initiators are amine-functionalized initiators, such as those that are the reaction product of an amine, an organo lithium and a solubilizing component. The initiator has the general formula:

(A) (SOL)_{y} Li where y is from about 1 to about 3; SOL is a solubilizing component selected from the group consisting of hydrocarbons, ethers, amines or mixtures thereof, and A is selected from the group consisting of alkyl, dialkyl and cycloalkyl amine radicals having the general formula: R₁ and cyclic amines having the general formula: R₂ where R₁ is selected from the group consisting of alkyls, cycloalkyls or aralkyls having from 1 to about 12 carbon atoms, and R₂ is selected from the group consisting of an alkylene, substituted alkylene, oxy- or N-alkylamino-alkylene group having from about 3 to about 16 methylene groups. An especially preferred functionalized lithium initiator is hexamethylene imine propyllithium.

Tin functionalized lithium initiators may also be preferred as useful in the present invention. Suitable tin functionalized lithium initiators include tributyl tin lithium, triocty tin lithium, and mixtures thereof.

Anionic initiators generally are useful in amounts ranging from about 0.01 to 60 millimoles per hundred grams of monomer charge.

A nano-particle including diblock polymers initiated with a functionalized initiator may include functional groups on the surface of the nano-particle. For example, when block polymers are initiated by hexamethylene imine propyllithium, the initiator residue remaining at the beginning of the polymer chain will contain an amine group. Once the polymer chains have aggregated and have been cross-linked, the resultant nano-particles will contain amine groups on or near the nano-particle surface.

An exemplary nano-particle formed from copolymers initiated by a functionalized tin lithium initiator may have a cross-linked alkenylbenzene core, for example polystyrene, and a surface layer including at least a poly(conjugated diene), for example 1,3-butadiene. The surface layer will also include a functionalized initiator residue at the individual chain ends (e.g., tin).

Polymer Nano-Particle Applications

A variety of applications are contemplated for use in conjunction with the nano-particles of the present invention. Furthermore, the several mechanisms described herein for modifying the nano-particles render them suitable for different applications. All forms of the present inventive nano-particles are, of course, contemplated for use in each of the exemplary applications and all other applications envisioned by the skilled artisan.

General Rubber

After the polymer nano-particles have been formed, they may be blended with a rubber to improve the physical characteristics of the rubber composition. Nano-particles are useful modifying agents for rubbers because they are discrete particles which are capable of dispersing uniformly throughout the rubber composition, resulting in uniformity of physical characteristics. Furthermore, the nano-particles disclosed herein are advantageous because of the improved physical properties which provide enhanced characteristics to the end product.

The present polymer nano-particles are suitable for modifying a variety of rubbers including, but not limited to, random styrene/butadiene copolymers, butadiene rubber, poly(isoprene), nitrile rubber, polyurethane, butyl rubber, EPDM, and the like. Advantageously, the inclusion of the present nano-particles result in rubbers having increased Tb, Eb, M300, and M50 at temperatures around 100° C. or higher.

Furthermore, nano-particles with hydrogenated surface layers may demonstrate improved compatibility with specific rubbers. For example, nano-particles including a hydrogenated polyisoprene surface layer may demonstrate superior bonding with and improved dispersion in an EPDM rubber matrix due to the compatibility of hydrogenated isoprene with EPDM rubber.

Additionally, nano-particles with copolymer surfaces may demonstrate improved compatibility with rubbers. The copolymer tails with the surface layer of the nano-particles may form a brush-like surface. The host composition is then able to diffuse between the tails allowing improved interaction between the host and the nano-particles.

Hard Disk Technology

Hydrogenated nano-particles prepared in accordance with the present invention may also find application in hard disk technology.

Disk drive assemblies for computers traditionally include a magnetic storage disk coaxially mounted about a spindle apparatus that rotates at speeds in excess of several thousand revolutions per minute (RPM). The disk drive assemblies also include a magnetic head that writes and reads information to and from the magnetic storage disk while the magnetic disk is rotating. The magnetic head is usually disposed at the end of an actuator arm and is positioned in a space above the magnetic disk. The actuator arm can move relative to the magnetic disk. The disk drive assembly is mounted on a disk base (support) plate and sealed with a cover plate to form a housing that protects the disk drive assembly from the environmental contaminant outside of the housing.

Serious damage to the magnetic disks, including loss of valuable information, can result by introducing gaseous and particulate contaminates into the disk drive assembly housing. To substantially prevent or reduce the introduction of gaseous and particulate contaminants into the disk drive housing, a flexible sealing gasket is disposed between the disk drive mounting base (support) plate and the disk drive assembly housing or cover plate. A sealing gasket is usually prepared by punching out a ring-shaped gasket from a sheet of cured elastomer. The elastomeric gasket obtained is usually attached to the base plate of the disk drive assembly mechanically, such as affixing the gasket with screws, or adhesives. In one embodiment, the hydrogenated nano-particles, when compounded with a polyalkylene and a rubber, demonstrate a tensile strength comparable to that suitable in hard disk drive compositions.

Thermoplastic Gels

Nano-particles prepared in accord with the present invention, whether hydrogenated or non-hydrogenated may also be blended with a variety of thermoplastic elastomers, such as SEPS, SEBS, EEBS, EEPE, polypropylene, polyethylene, and polystyrene. For example, nano-particles with hydrogenated isoprene surface layers may be blended with a SEPS thermoplastic to improve tensile strength and thermostability. These blends of thermoplastic elastomer and nano-particles may be extended. For example, suitable extenders include extender oils and low molecular weight compounds or components. Suitable extender oils include those well known in the art such as naphthenic, aromatic and paraffinic petroleum oils and silicone oils.

Examples of low molecular weight organic compounds or components useful as extenders in compositions of the present invention are low molecular weight organic materials having a number-average molecular weight of less than 20,000, preferably less than 10,000, and most preferably less than 5000. Such compounds or components are commercially available. Although there is no limitation to the material which may be employed, the following is a non-exhaustive list of examples of appropriate materials:
(1) Softening agents, namely aromatic naphthenic and parraffinic softening agents for rubbers or resins;
(2) Plasticizers, namely plasticizers composed of esters including phthalic, mixed pthalic, aliphatic dibasic acid, glycol, fatty acid, phosphoric and stearic esters, epoxy plasticizers, other plasticizers for plastics, and phthalate, adipate, scbacate, phosphate, polyether and polyester plasticizers for NBR;
(3) Tackifiers, namely coumarone resins, coumaroneindene resins, terpene phenol resins, petroleum hydrocarbons and rosin derivative;
(4) Oligomers, namely crown ether, fluorine-containing oligomers, polybutenes, xylene resins, chlorinated rubber, polyethylene wax, petroleum resins, rosin ester rubber, polyalkylene glycol diacrylate, liquid rubber (polybutadiene, styrene/butadiene rubber, butadiene-acrylonitrile rubber, polychloroprene, etc.), silicone oligomers, and poly-a-olefins;
(5) Lubricants, namely hydrocarbon lubricants such as paraffin and wax, fatty acid lubricants such as higher fatty acid and hydroxy-fatty acid, fatty acid amide lubricants such as fatty acid amide and alkylene-bisfatty acid amide, ester lubricants such as fatty acid-lower alcohol ester, fatty acid-polyhydric alcohol ester and fatty acid-polyglycol ester, alcoholic lubricants such as fatty alcohol, polyhydric alcohol, polyglycol and polyglycerol, metallic soaps, and mixed lubricants; and,
(6) Petroleum hydrocarbons, namely synthetic terpene resins, aromatic hydrocarbon resins, aliphatic hydrocarbon resins, aliphatic or alicyclic petroleum resins, polymers of unsaturated hydrocarbons, and hydrogenated hydrocarbon resins.

Other appropriate low-molecular weight organic materials include latexes, emulsions, liquid crystals, bituminous compositions, and phosphazenes. One or more of these materials may be used in as extenders.

Tire Rubber

One application for nano-particle containing rubber compounds is in tire rubber formulations.

Vulcanizable elastomeric compositions of the invention are prepared by mixing a rubber, a nanoparticle composition, with a reinforcing filler comprising silica, or a carbon black, or a mixture of the two, a processing aid and/or a coupling agent, a cure agent and an effective amount of sulfur to achieve a satisfactory cure of the composition.

The preferred rubbers are conjugated diene polymers, copolymers or terpolymers of conjugated diene monomers and monovinyl aromatic monomers. These can be utilized as 100 parts of the rubber in the tread stock compound, or they can be blended with any conventionally employed treadstock rubber which includes natural rubber, synthetic rubber and blends thereof. Such rubbers are well known to those skilled in the art, commercially available, and include synthetic polyisoprene rubber, styrene-butadiene rubber (SBR), styrene-isoprene rubber, styrene-isoprene-butadiene rubber, butadiene-isoprene rubber, polybutadiene, butyl rubber, neoprene, acrylonitrile-butadiene rubber (NBR), silicone rubber, the fluoroelastomers, ethylene acrylic rubber, ethylene-propylene rubber, ethylene-propylene terpolymer (EPDM), ethylene vinyl acetate copolymer, epichlorohydrin rubber, chlorinated polyethylene-propylene rubbers, chlorosulfonated polyethylene rubber, hydrogenated nitrile rubber, tetrafluoroethylene-propylene rubber, and the like.

Examples of reinforcing silica fillers which can be used in the vulcanizable elastomeric composition include wet silica (hydrated silicic acid), dry silica (anhydrous silicic acid), calcium silicate, and the like. Such reinforcing fillers are commercially available. Other suitable fillers include aluminum silicate, magnesium silicate, and the like. Among these, precipitated amorphous wet-process, hydrated silicas are preferred. Silica can be employed in the amount of about one to about 100 parts per hundred parts of the elastomer (pph), preferably in an amount of about 5 to 80 pph and, more preferably, in an amount of about 30 to about 80 pphs. The useful upper range is limited by the high viscosity imparted by fillers of this type. Some of the commercially available silica which can be used include, but are not limited to, HiSil® 190, HiSil® 210, HiSil® 215, HiSil® 233, HiSil® 243, and the like, produced by PPG Industries of Pittsburgh, Pa. A number of useful commercial grades of different silicas are also available from DeGussa Corporation (e.g., VN2, VN3), Rhone Poulenc (e.g., Zeosil® 1165 MP0), and J. M. Huber Corporation.

Including surface functionalized nano-particles in silica containing rubber compositions has been shown to decrease the shrinkage rates of such silica containing rubber compositions. Functionalized nano-particles may be compounded in silica compositions in concentrations up to about 30 wt % of the total composition, more preferably up to about 40 wt %, most preferably up to about 50 wt %.

The rubber can be compounded with all forms of carbon black, optionally additionally with silica. The carbon black can be present in amounts ranging from about one to about 100 phr. The carbon black can include any of the commonly available, commercially-produced carbon blacks, but those having a surface of at least 20 m²/g and, or preferably, at least 35 m²/g up to 200 m²/g or higher are preferred. Among useful carbon blacks are furnace black, channel blacks, and lamp blacks. A mixture of two or more of the above blacks can be used in preparing the carbon black products of the invention. Typical suitable carbon black are N-110, N-220, N-339, N-330, N-352, N-550, N-660, as designated by ASTM D-1765-82a.

Certain additional fillers can be utilized including mineral fillers, such as clay, talc, aluminum hydrate, aluminum hydroxide and mica. The foregoing additional fillers are optional and can be utilized in the amount of about 0.5 phr to about 40 phr.

Numerous coupling agents and compatibilizing agents are known for use in combining silica and rubber. Among the silica-based coupling and compatibilizing agents include silane coupling agents containing polysulfide components, or structures such as, for example, trialkoxyorganosilane polysulfides, containing from about 2 to about 8 sulfur atoms in a polysulfide bridge such as, for example, bis-(3-triethoxysilylpropyl) tetrasulfide (Si69), bis-(3-triethoxysilylpropyl) disulfide (Si75), and those alkyl alkoxysilanes of the such as octyltriethoxy silane, and hexyltrimethoxy silane.

It is readily understood by those having skill in the art that the rubber composition would be compounded by methods generally known in the rubber compounding art, such as mixing the various vulcanizable polymer(s) with various commonly used additive materials such as, for example, curing agents, activators, retarders and accelerators processing additives, such as oils, resins, including tackifying resins, plasticizers, pigments, additional filers, fatty acid, zinc oxide, waxes, antioxidants, anti-ozonants, and peptizing agents. As known to those skilled in the art, depending on the intended use of the sulfur vulcanizable and sulfur vulcanized material (rubbers), the additives mentioned above are selected and commonly used in the conventional amounts.

Specifically, the above-described nano-particle containing rubber compounds are contemplated for use in rubber compounds used to make tire treads and side walls due to the enhanced reinforcement capabilities of the present nano-particles. The higher dynamic modulus (G′) and its lower temperature dependence along with the lower hysteresis values at high temperature leads to the improved cornering, handling, dry, snow, and wet traction, rolling resistance, dispersion, and aging properties of the resultant tire compositions. Improved aging properties, thermal aging (high temperature), or mechanical aging (static or dynamic deformation cycles), include retention of the G′ modulus, hysteresis, mechanical strengths, etc. Tin-functionalized nano-particles are especially suited for use in tire compositions. Nano-particles including a copolymer surface layer are also suitable for use in such tire compositions, because the longer copolymer chains in the surface layer leads to greater diffusion of the host rubber composition into the surface layer of the nano-particle. An example of a preferred copolymer chain is one in the range of 50,000 to 150,000 daltons. Also, an advantage of using a copolymer of such minimum length is greater diffusion of the host rubber composition into the surface layer of the nano-particle. Of course, the functionalized nano-particle having a copolymer surface layer, i.e., the combination of the two alternatives may also be beneficial.

Engineering Plastics and Others

Similarly, the nano-particles can be added into typical plastic materials, including polyethylene, polypropylene, polystyrene, polycarbonate, nylon, polyimides, etc. to for example, enhance impact strength, tensile strength and damping properties. It is understood that generally known methods in the plastic arts would be used.

Of course, the present inventive nano-particles are also suited to other presently existing applications for nano-particles, including the medical field, e.g. drug delivery and blood applications, information technology, e.g. quantum computers and dots, aeronautical and space research, energy, e.g., oil refining, and lubricants.

Engine Mount, Etc.

Another application for such rubbers is in situations requiring superior damping properties, such as engine mounts and hoses (e.g. air conditioning hoses). Rubber compounds of high mechanical strength, super damping properties, and strong resistance to creep are preferred in engine mount manufacturers. In engine mounts, a rubber, because it sits most of its life in a packed and hot position, requires very good high temperature characteristics. Utilizing the nano-particles within selected rubber formulations can improve the characteristics of the rubber compounds.

The present invention now will be described with reference to non-limiting examples. The following examples and tables are presented for purposes of illustration only and are not to be construed in a limiting sense.

### EXAMPLES

### Example 1

### Preparation of the Polymer Particles

A stainless steel two gallon reactor was charged with 1.23 lbs hexane and 2.00 lbs. butadiene. The jacket of the reactor was then heated to 165° F. When the temperature of the contents of the reactor reached 150° F., then 4.7 ml of 1.68 M n-butyl lithium, which was diluted with about 20 ml of hexane was added. Due to the exothermic nature of the polymerization reaction, the temperature of the contents of the reactor elevated to about 181.9° F. The temperature elevation occurred during a nine minute period. About 15 minutes after the rise in temperature was complete, a styrene blend (1.35 lbs) was added to the reactor. Again, an exothermic reaction within the reactor elevated the temperature of the contents of the reactor to a temperature of about 193.9° F. The change in temperature takes about 15 minutes. About 15 minutes after the temperature elevation is complete, 4.01 lbs of hexane were added to the reactor. Then, 8.5 ml of 0.94 M diphenylethylene was added. The contents of the reactor were mixed and incubated for 30 minutes.

The jacket temperature was lowered to 50° F. and 25 ml OOPS (1.68 M), 40 ml of lithium t-butoxide (1.0 M) and 111.2 grams of Bisphenol A ethoxylate (1 EO/phenol) diacrylate were added to the reaction mixture. The reaction mixture continued to be mixed and was incubated for 2 hours, then the jacket temperature was increased to 165° F. The reaction mixture was then mixed and incubated for 1.5 hours at the elevated temperature.

Subsequent to the reaction, the contents of the reactor were placed in a mixture of 4 liters of isopropanol and 5 grams BHT which caused the production of a solid. The solid was then filtered through cheesecloth and dried with heat and pressure via a drum-drier.

Regarding the materials, the butadiene in hexane contains 21.6 weight percent butadiene, the styrene in hexane contains 33 weight percent styrene, the n-butyl lithium was 1.68 M, the oligomeric oxolanyl propanes (OOPS) was from Penn Specialty Chemical and is 1.6M, and butylated hydroxytoluene (BHT) and other materials not specifically mentioned were purchased from commercial sources. Lithium t-butoxide (1.0 M) was purchased form Aldrich. Diphenyl ethylene was purchased from Aldrich and in use as a 0.94 M solution in hexane on calcium hydride. Bisphenol A ethoxylate (1 EO/phenol) diacrylate was purchased from Aldrich and was stored on alumina beads (to remove the inhibitor) and calcium hydride under nitrogen. THF was purified on a drying column before use. Divinylbenzene was purchased from Aldrich (80% divinylbenzene) and stored on alumina beads and calcium hydride.

### Example 2

A two gallon stainless steel reactor was charged with 1.2 lbs hexane and 2.01 lbs butadiene (22.4 weight percent butadiene). The jacket of the rector was heated to 165° F. When the temperature of the contents of the reactor reached 150° F., 4.7 ml of 1.68 M n-butyl lithium was added. The n-butyl lithium was diluted with about 20 ml of hexane. The exothermic polymerization reaction, which took about 8 minutes, raised the temperature of the contents of the reactor to 172.6° F. Thirty minutes after the top temperature was reached, styrene (1.36 lbs) was added to the reactor, the jacket of which was still heated to a temperature to 165° F. After the styrene was added, the resulting exothermic reaction raised the temperature to 175.3° F. during a period of time which lasted about 9 minutes. After 20 minutes, 4.00 lbs hexane was added, in order to favor the formation of micelles. 10 ml of divinylbenzene was then added. After incubating the reaction mixture for 20 minutes, 8 ml of 1 M diphenylethylene was added. The reaction mixture continued to be mixed and was incubated for 30 minutes, then 25 ml of OOPS (1.68 M), 40 ml of lithium t-butoxide (1.0 M) and 111.2 g of Bisphenol A Ethoxylate (1 EO/phenol) diacrylate in 946 ml of THF were added to the reaction mixture. The reaction mixture was mixed and incubated for 1.5 hours with the jacket temperature set at 165° F. The reaction mixture was then mixed and incubated for 19 hours at room temperature. The reaction mixture was then placed in isopropanol containing BHT (4 liters of isopropanol containing 5 grams BHT). The solid was then filtered through cheesecloth and drum-dried.

### Example 3

A two gallon stainless steel reactor was charged with 1.22 lbs hexane and 2.02 lbs butadiene (21.0 weight percent butadiene). The jacket of the reactor was heated to 165° F. When the temperature of the contents of the reactor reached 150° F., 4.7 ml of 1.68 M n-butyl lithium was added. The n-butyl lithium was diluted with about 20 ml of hexane. The exothermic polymerization reaction elevated the temperature of the contents of the reactor to 180.9° F. during a period of time of about 11 minutes. The reaction mixture was mixed and incubated for about 15 minutes, then styrene (1.36 lbs) was added to the reactor, while the jacket temperature was still set at 165° F. The exothermic polymerization reaction raised the temperature of the contents of the reactor to 185.3° F. over a period of about 16 minutes. After the maximum temperature was reached, the reaction mixture was mixed and incubated for 18 minutes, then 4.04 lbs hexane was added. Thereafter, 10 ml of divinylbenzene is added. The reaction mixture is mixed and incubated for about 30 minutes, then 8 ml of 1 M diphenylethylene was added. After mixing and incubating the reaction mixture for 39 minutes, 25 ml OOPS (1.68 M), 40 ml of lithium t-butoxide (1.0 M) and 72.5 g of (diethylene glycol) diacrylate in 395 ml of THF were added to the reaction mixture. The reaction mixture was mixed and incubated for 3 hours at 165° F. The reaction mixture was then placed in isopropanol containing BHT (4 liters of isopropanol containing 5 grams BHT). The solid was then filtered through cheesecloth and drum-dried.

### Example 4

The two gallon reactor was charged with 1.20 lbs hexane and 2.00 lbs butadiene (21.0 weight percent butadiene). The jacket of the reactor was heated to 165° F. When the temperature of the contents of the reactor reached 150° F., 4.7 ml of 1.68 M n-butyl lithium is added, which is diluted with about 20 ml of hexane. The exothermic polymerization reaction elevated the temperature of the contents of the reactor to a temperature of 180.5° F. during a 10 minute period of time. After 25 minutes of mixing and incubating the reaction mixture, styrene (1.36 lbs) was added to the reactor, while maintaining the jacket temperature to 165° F. Another exothermic reaction elevated the temperature of the contents of the reactor to 191.2° F. during a 12 minute period of time. The reaction mixture was mixed and incubated for 27 minutes, then 4.01 lbs hexane was added. Then, 10 ml of divinylbenzene was added. After mixing and incubating the reaction mixture for 28 minutes, 8 ml of 1 M diphenylethylene was added. After incubating for 33 minutes, 25 ml OOPS (1.68 M), 40 ml of lithium t-butoxide (1.0 M) and 126.8 g of (diethylene glycol) diacrylate were added to the reaction mixture. The reaction mixture was mixed and incubated for 3 hours at a temperature of 165° F. The reaction mixture was then placed in isopropanol containing BHT (4 liters of isopropanol containing 5 grams BHT). The solid was then filtered through cheesecloth and drum-dried.

### Example 5

A two gallon stainless steel reactor was charged with 0.61 lbs hexane and 1.03 lbs butadiene (21.0 weight percent butadiene). The jacket of the reactor was heated to 165° F. When the contents of the reactor reach 150° F., then 2.3 ml of 1.68 M n-butyl lithium was added, which was diluted with about 20 ml of hexane. The exothermic polymerization reaction raised the temperature of the contents of the reactor to 162.7° F. during a 10 minute period of time. After 15 minutes of mixing and incubation, styrene (0.67 lbs) was added to the reactor, while maintaining the jacket temperature to 165° F. The exothermic reaction raised the temperature of the contents of the reactor to 170.5° F. during a 13 minute period of time. After mixing and incubating the reaction mixture for 21 minutes, 2.05 lbs hexane was added. Then, 5 ml of divinylbenzene was added. After 30 minutes, 4 ml of 1 M diphenylethylene was added. After 33 minutes, 12 ml OOPS (1.68 M), 20 ml of lithium t-butoxide (1.0 M) and 122.6 g of poly(ethylene glycol) diacrylate in 1.77 L of THF were added to the reaction mixture. The reaction mixture was mixed and incubated for 3 hours at a temperature of 165° F. The reaction mixture was then placed in isopropanol containing BHT (4 liters of isopropanol containing 5 grams BHT). The solid was then filtered through cheesecloth and drum-dried.

### Example 6

A two gallon stainless steel reactor is charged with 0.62 lbs hexane and 1.01 lbs butadiene (21.0 weight percent butadiene). The jacket of the reactor was heated to 165° F. When the temperature of the contents of the reactor reached 150° F., then 2.3 ml of 1.68 M n-butyl lithium was added. The n-butyl lithium was diluted with about 20 ml of hexane. The polymerization reaction was exothermic, so the temperature of the contents of the reactor rose to 165.0° F. during a period of 11 minutes. After 20 minutes of mixing, styrene (0.67 lbs) was added to the reactor, while maintaining the jacket temperature to 165° F. Another exothermic reaction was responsible for raising the temperature of the contents of the reactor to 159.4° F. during a period of 11 minutes. After 34 minutes of mixing, 2.01 lbs hexane was added. Then, 5 ml of divinylbenzene was added. After 32 minutes of mixing, 4 ml of 1 M diphenylethylene was added. After 32 minutes of mixing, 12 ml OOPS (1.68 M), 19.5 ml of lithium t-butoxide (1.0 M) and 87.8 g of trimethylol propane ethoxylate triacrylate in 920 ml of THF were added to the reaction mixture. The reaction mixture was mixed and incubated for 3 hours at a temperature of 165° F. The reaction mixture was then placed in isopropanol containing BHT (4 liters of isopropanol containing 5 grams BHT). The solid was then filtered through cheesecloth and drum-dried.

### Example 7

### Application of the Particles in Rubber Compounds

Three kinds of rubber compositions were prepared according to the formulation shown in Tables 4 and 5. Note that the total of the polybutadiene and polymer micelle equals 100. For comparison, two controls were used. Experiments 1 and 6 contained no polymer micelles and experiments 2 and 3 contained DVB-core polymer micelles.

Referring to Tables 4 and 5, the vulcanized rubber compounds of experiments 1-6 give the results shown. As can be seen in Table 4, the diacrylate-core micelles maintained their properties at 100° C. better than the DVB core micelles. The measurement of tensile strength and tear strength is shown, for the temperature indicated in the table (ASTM-D 412 and ASTM-D 624, respectively). Regarding the test specimen geometry, the ring had a width of 0.05 inches and a thickness of 0.075 inches. The specimen was tested at a specific gauge length of 1.0 inch. Test specimen geometry was taken in the form of a nicked ring (ASTM-624-C). The specimen was tested at the specific gauge length of 1.750 inches. The hysteresis loss was measured with a Dynastat Viscoelastic Analyser. Test specimen geometry was taken in the form of a cylinder with a diameter of 30 mm and of a length of 15 mm. The results were obtained by using the following testing conditions: frequency 1 Hz, dynamic mass 1.25 MPa, and static mass 2.00 MPa.

### Example 8

Acrylate containing cross-linked micelles do not suffer as much property loss at higher temperatures as compared to micelles not having a polar core, as further described below. For example, the following results were obtained by testing the acrylate containing cross-linked micelles made as described according to example 1. When comparing the above-mentioned acrylate containing micelles to micelles having DVB, the modulus at 300% (M300) at 23° C. was equal. However, at 100° C., the Tb of the acrylate containing cross-linked micelles decreased by 47.5%, compared to 52.5% for regular micelles. Also, again at 100° C., the Eb of the acrylate containing cross-linked micelles decreased by 28.6% compared to the regular micelles which decreased by 32.5%. Additionally, the M300 of the acrylate containing cross-linked micelles decreased by 15.4%, rather than 17.2% for regular micelles, and the modulus at 50% (M50) decreased by 17.1%, rather than 19.4%, respectively.

### Example 9

Shown in Table 4 are experimental results which were obtained by testing the micelles made according to example 1. After the synthesis of the micelles, rubber compositions were prepared according to the formulations in Table 1 and Table 2. As shown in columns 4 and 5 of Table 4, the rubber composition had a Tb at 100° C. of from about 8.15 MPa to about 7.55 MPa; Eb at 100° C. of from about 320% to about 370%; and M300 at 100° C. of from about 6.2 KPa to about 6.9 KPa. The rubber composition also had an M50 at 100° C. of from about 1.00 KPa to about 1.07 KPa.

As previously described above, three kinds of rubber compositions were prepared according to the formulation shown in Tables 1 and 2 by selectively using the synthesized particles to replace the amount of polymer (polybutadiene) in the compound formulation. The nano-particles used in this example were derived from Example 1. In each sample, a blend of the ingredients was kneaded by the method described in Table 3.

TABLE 1
Composition of Master Batch

| Component | Concentration (phr) |
|---|---|
| Rubber | 100 |
| Carbon black | 50 |
| Aromatic oil | 15 |
| Zinc oxide | 3 |
| Hydrocarbon resin | 2 |
| (tackifiers) | |
| Antioxidants | 0.95 |
| Stearic Acid | 2 |
| Wax | 1 |

TABLE 2
Composition for Final Batch

| Component | Concentration (phr) |
|---|---|
| Sulfur (curing agent) | about 1.30 |
| Cyclohexyl-benzothiazole | 1.4 |
| sulfenamide (accelerator) | |
| Diphenylguanidine (accelerator) | 0.2 |

TABLE 3

| | |
|---|---|
| Mixing Conditions | |
| Mixer | 300 g Brabender |
| Agitation Speed | 60 rpm |
| Master Batch Stage | |
| Initial Temperature | 110 C. |
| 0 minutes | Charging polymers |
| 0.5 minutes | Charging oil and carbon black |
| 5.0 minutes | Drop |
| Final Batch Stage | |
| Initial Temperature | 75 C. |
| 0 seconds | Charging master stock |
| 30 seconds | Charging curing agent |
| 75 seconds | Drop |

TABLE 4
Summary of the Experimental Results

| Experiment | | 1 | 2 | 3 | 4 | 5 | 6 |
|---|---|---|---|---|---|---|---|
| | | control | | | control | | |
| Polymer | (DVB core) | | 10 | 10 | | | |
| | (polar core) | | | | 10 | 10 | |
| HX301 | (Diene 40NFBR | 100 | 90 | 90 | 90 | 90 | 100 |
| | Rubber) | | | | | | |
| | (Firestone | | | | | | |
| | Polymers) | | | | | | |
| Carbon | (RP 16474) | 50 | 50 | 50 | 50 | 50 | 50 |
| Black | | | | | | | |
| Aromatic | | 15 | 15 | 15 | 15 | 15 | 15 |
| Oil | | | | | | | |
| Sulfur | | 1.3 | 1.3 | 1.5 | 1.3 | 1.5 | 1.6 |
| Compounds | | | | | | | |
| 130° C. ML4 | | 41.97 | 43.09 | 42.7 | 42.87 | 43.26 | 42.24 |
| Viscosity | | | | | | | |
| MDR 2000 | 165° C. MH | 16.08 | 16.33 | 17.26 | 16.03 | 16.75 | 17.44 |
| | T90 | 5.78 | 5.59 | 5.52 | 5.63 | 5.33 | 5.1 |
| Shore A | 22° C. (3 sec) | 59.2 | 63.0 | 62.7 | 61.8 | 61.2 | 60.6 |
| | 100° C. (3 sec) | 58.1 | 58.1 | 57.6 | 57.0 | 57.0 | 56.1 |
| Ring Tensile | | | | | | | |
| 23° C. | Tb (MPa) | 15.38 | 15.91 | 14.95 | 14.47 | 14.37 | 14.45 |
| | Eb (%) | 537 | 506 | 462 | 491.2 | 451 | 462 |
| | M300 | 6.33 | 7.65 | 8.14 | 7.24 | 8.12 | 7.4 |
| | M50 | 1.03 | 1.24 | 1.29 | 1.2 | 1.29 | 1.11 |
| 100° C. | Tb (MPa) | 7.76 | 7.97 | 7.1 | 8.16 | 7.55 | 6.81 |
| | Eb (%) | 370 | 363 | 312 | 367 | 322 | 296 |
| | M300 | 5.82 | 6.17 | 6.74 | 6.24 | 6.872 | 6.85 |
| | M50 | 0.93 | 0.99 | 1.04 | 1.00 | 1.07 | 1.06 |

TABLE 5
Summary of the Experimental Results

| Experiment | | 1 | 2 | 3 | 4 | 5 | 6 |
|---|---|---|---|---|---|---|---|
| | | control | | | control | | |
| Polymer | (DVB core) | | 10 | 10 | | | |
| | (polar core) | 10 | 10 | | | | |
| HX301 | (Diene | 100 | 90 | 90 | 90 | 90 | 100 |
| | 40NFBR | | | | | | |
| | Rubber) | | | | | | |
| | (Firestone | | | | | | |
| | Polymers) | | | | | | |
| Carbon Black | (RP16474) | 50 | 50 | 50 | 50 | 50 | 50 |
| Aromatic Oil | 15 | 15 | 15 | 15 | 15 | 15 | |
| Sulfur | 1.3 | 1.3 | 1.5 | 1.3 | 1.5 | 1.6 | |
| Compounds | | | | | | | |
| 130° C. ML4 | 41.97 | 43.09 | 42.7 | 42.87 | 43.16 | 42.24 | |
| Viscosity | | | | | | | |
| MDR 2000 | 165° C. MH | 16.08 | 16.33 | 17.26 | 16.03 | 16.75 | 17.44 |
| | T90° C. | 5.78 | 5.59 | 5.525 | 5.63 | 5.33 | 5.1 |
| Dynastat | M′ at 50° C. | 6.187 | 8.7714 | 9.3219 | 8.8639 | 9.0582 | 7.2401 |
| | tand at 50° C. | 0.17922 | 0.20306 | 0.19404 | 0.20198 | 1.9612 | 1.6185 |
| | M′ at 23° C. | 7.9442 | 11.103 | 11.732 | 11.200 | 11.381 | 8.3430 |
| | tand at 23° C. | 0.20813 | 0.22583 | 0.21648 | 0.22305 | 0.21748 | 0.19031 |
| | M′ at 0° C. | 9.4468 | 13.851 | 14.513 | 14.022 | 14.249 | 9.8863 |
| | tand at 0° C. | 0.23555 | 0.24883 | 0.23908 | 0.24381 | 0.24026 | 0.22087 |
| | M′ at 20° C. | 11.320 | 16.465 | 16.960 | 16.229 | 16.118 | 11.015 |
| | tand at 20° C. | 0.25378 | 0.2674 | 0.26159 | 0.26112 | 0.25976 | 0.23898 |

This patent application incorporates by reference all references and publications disclosed herein.

Thus, although there have been described particular embodiments of the present invention of new and useful Amphiphilic Polymer Micelles and Use Thereof, it is not intended that such references be construed as limitations upon the scope of this invention except as set forth in the following claims.

1. A nano-particle, comprising:
a micelle comprising a polar core and a hydrophobic shell,
wherein the polar core has at least one oxygen, nitrogen, or sulfur atom, a mean average diameter of the nano-particle comprises less than about 100 nm.

2. The nano-particle of claim 1, wherein the polar core comprises at least one oxygen atom.

3. The nano-particle of claim 1 wherein the micelle comprises a polymerization reaction product.

4. The nano-particle of claim 3 wherein the polymerization reaction product comprises a result of a multi-stage polymerization.

5. A rubber composition, comprising:
a rubber; and
a plurality of nano-particles, at least a majority of the nano-particles monodispersed in the rubber, the nano-particles comprising:
a polymerization reaction product comprising a micelle, the micelle comprising a polar core and a hydrophobic shell,
wherein the polar core comprises at least one oxygen, nitrogen, or sulfur atom, a mean average diameter of at least one of the nano-particles comprises less than about 100 nm.

6. The rubber composition of claim 5, wherein the polar core comprises at least one oxygen atom.

7. The rubber composition of claim 5, wherein Tb at 100° C. comprises from about 8.15 MPa to about 7.55 MPa.

8. The rubber composition of claim 5, wherein Eb at 100° C. comprises from about 320% to about 370%.

9. The rubber composition of claim 5, wherein M300 at 100° C. comprises from about 6.2 KPa to about 6.9 KPa.

10. The rubber composition of claim 5, wherein M50 at 100° C. comprises from about 1.00 KPa to about 1.07 KPa.

11. A method of preparing nano-sized polymer particles, comprising:
polymerizing a plurality of monomers in a hydrocarbon solvent to form a polymer; and
combining a polar cross-linking agent with the polymer to produce nano-sized polymer particles comprising a polar core and a hydrophobic shell, a mean average diameter of the nano-sized polymer particles comprises less than about 100 nm.

12. The method of claim 11, wherein combining further comprises using a ratio by weight of the plurality of monomers to the polar cross-linking agent of from about 0.5:1 to about 5:1.

13. The method of claim 11, wherein a temperature range of the polymerizing step comprises from about 0° C. to about 250° C.

14. The method of claim 11, wherein the plurality of monomers comprise alkenylbenzene and conjugated diene monomers.

15. The method of claim 11, wherein the plurality of monomers comprise a vinyl aromatic hydrocarbon monomer, a vinyl-substituted aromatic hydrocarbon monomer, or a conjugated diene monomer.

16. The method of claim 11, wherein the polar cross-linking agent has at least one oxygen, sulfur, or nitrogen atom.

17. A nano-particle composition, comprising:
a polar core; and
a surface layer comprising poly(conjugated diene), poly(alkylene), or mixtures thereof wherein a mean average diameter of the nano-particles comprises less than about 100 nm.

18. The composition of claim 17, further comprising at least one functional group.

19. The composition of claim 18, wherein the functional group is associated with the surface layer.

20. The composition of claim 17, wherein the surface layer further comprises vinyl-substituted aromatic hydrocarbon monomer units.

21. The composition of claim 20, wherein the surface layer comprises at least one diblock polymer chain.

22. The composition of claim 21, wherein the core comprises substantially at least one mono-block polymer chain.

23. The composition of claim 22, wherein the mono-block polymer chains and the diblock polymer chains are cross-linked.

24. The composition of claim 17, wherein the polar core further comprises an acrylate containing cross-linking agent selected from bisphenol A ethoxylate diacrylate, (diethylene glycol) diacrylate, poly(ethylene glycol) diacrylate, and trimethylol propane ethoxylate triacrylate.

25. The composition of claim 17, wherein the polar core further comprises glycerol propoxylate triacrylate.

26. A rubber composition, comprising:
a rubber, and
a polymer nano-particle having a core and a surface layer comprising monomer units including conjugated dienes, alkylenes, or mixtures thereof, the core comprising poly(alkenylbenzene) and an acrylate containing cross-linking agent.

27. The rubber composition of claim 26, further comprising an inorganic filler.

28. The composition of claim 26, wherein the rubber selected from random styrene/butadiene copolymers, butadiene rubber, polyisoprene, nitrile rubber, polyurethane, butyl rubber, EPDM, and mixtures thereof.

29. The composition of claim 26 wherein the polymer nano-particle further comprises a functional group selected from carboxylic acid, alcohol, amine, formyl, tin, silicon, silyl ether, and mixtures thereof.

30. The composition of claim 26 wherein the surface layer further comprises alkenylbenzene monomer units.

31. A thermoplastic elastomer composition, comprising:
a thermoplastic elastomer; and
a polymer nano-particle comprising a core and a surface layer comprising monomer units including conjugated dienes, alkylenes, and mixtures thereof, the core comprising poly(alkenylbenzene) and an acrylate containing cross-linking agent.

32. The composition of claim 31, further comprising a sufficient amount of an extender to form a gel.

33. The composition of claim 31, wherein the thermoplastic elastomer is selected from SEPS, SEBS, SEPE, SEBE, EEBE, EEPE polypropylene, polyethylene, polystyrene, and mixtures thereof.

34. The composition of claim 31, wherein the acrylate containing cross-linking agent comprises at least one selected from bisphenol A ethoxylate diacrylate, (diethylene glycol) diacrylate, poly(ethylene glycol) diacrylate, and trimethylol propane ethoxylate triacrylate and mixtures thereof.

35. The composition of claim 31, wherein the polar core further comprises glycerol propoxylate triacrylate.

36. The composition of claim 25 further comprising a silica and the surface layer further comprising alkenylbenzene monomer.

37. The composition of claim 36, wherein the acrylate containing cross-linking agent comprises at least one selected from bisphenol A ethoxylate diacrylate, (diethylene glycol) diacrylate, poly(ethylene glycol) diacrylate, and trimethylol propane ethoxylate triacrylate and mixtures thereof.

38. The composition of claim 36, wherein the polar core further comprises glycerol propoxylate triacrylate.

39. A tire comprising the composition of claim 26.

40. A hard disk drive gasket composition, comprising:
a rubber;
a polyalkylene; and
a polymer nano-particle including a core and a surface layer including monomer units selected from at least one conjugated dienes, alkylenes, alkenylbenzene and mixtures thereof, the core comprising poly(alkenylbenzene) and an acrylate containing cross-linking agent.

41. The composition of claim 40, wherein the rubber is selected from random styrene/butadiene copolymers, butadiene rubber, polyisoprene, nitrile rubber, polyurethane, butyl rubber, EPDM, and mixtures thereof.

42. The composition of claim 40, wherein the polymer nano-particle further comprises a functional group selected from carboxylic acids, alcohols, amines, formyl, tin, silica, and mixtures thereof.

43. The composition of claim 40, wherein the acrylate containing cross-linking agent selected from bisphenol A ethoxylate diacrylate, (diethylene glycol) diacrylate, poly(ethylene glycol) diacrylate, and trimethylol propane ethoxylate triacrylate.

44. The composition of claim 40, wherein the polar core further comprises glycerol propoxylate triacrylate.

45. A method of preparing a functionalized polymer nano-particle composition comprising:
polymerizing an alkenylbenzene monomer and a conjugated diene monomer in a hydrocarbon solvent, in the presence of a functionalized initiator, to form a diblock polymer;
forming a polymerization mixture including micelles of the diblock polymer; and
adding an acrylate containing cross-linking agent to the polymerization mixture to form cross-linked nano-particles from the micelles, a mean average diameter of the nano-particles comprises less than about 100 nm.

46. The method of claim 45 wherein the functionalized initiator comprises a functionalized lithium initiator.

47. The method of claim 45 wherein the functionalized lithium initiator includes a functional group selected from carboxylic acids, alcohols, amines, formyl, tin, silicon, silyl ether, and mixtures thereof.

48. The method of claim 45 wherein the functionalized lithium initiator comprises hexamethylene imine propyllithium.

49. The method of claim 45 further including a hydrogenation step.
